(19) United States
(12) Patent Application Publication
(10) Pub. No.: US 2006/0092088 A1
(43) Pub. Date: May 4, 2006

(54) Receiving a television satellite signal or transmission without attaching a satellite dish to the outer wall of a home or dwelling

(76) Inventor: Anthony G. Edwards, Marina Del Rey, CA (US)

Correspondence Address: TROJAN LAW OFFICES, 9250 WILSHIRE BLVD, SUITE 325, BEVERLY HILLS, CA, 90212, US

(21) Appl. No.: 10/977,907

(22) Filed: Oct. 30, 2004

(51) Int. Cl. H01Q 1/42

(52) U.S. Cl. 343/872

(57) ABSTRACT

An acrylic material such as Plexiglas, which allows an incoming television satellite signal or transmission to pass through it, is used instead of glass between the satellite signal and the satellite dish which is mounted within the structure or dwelling facing the satellite making it possible to receive a satellite signal without mounting a satellite dish on the outside wall or on top of the structure.

The traditional method of receiving a television satellite signal or transmission is by mounting a satellite dish on the outer wall of a building, home or dwelling and adjusting the dish to the correct azimuth, elevation and skew after the dish is placed in a position facing the satellite.

The satellite signal will not penetrate glass without distorting but if the glass is replaced by and acrylic material such as Plexiglas, of which there are many kinds, the signal can pass through without distorting. The signal strength will be diminished but the picture will still not distort. Consequently, the dish can be mounted inside the structure, home or dwelling where it can be constructed of a lighter weight material, made more attractive and easier to adjust.

### BRIEF SUMMARY OF INVENTION

Up until now if a person wished to receive television satellite signals it was necessary to secure a satellite dish to the outer wall or on top of the structure within which they wished to receive the signal. If it was not possible or permissible to mount the dish in this manner they could not receive the signal.

With this invention they can mount the dish inside the structure and receive a signal by simply replacing the glass in a window or opening that faces the satellite with an acrylic material such as plexiglas which permit's a satellite signal or transmission to pass through it.

Material of varying thickness will work but quarter inch clear is preferred since it is similar in appearance to ordinary glass. This invention is useful to companies like Dish Network, Direct TV and Echo Star who sell satellite television time in cases where the subscriber is not permitted to secure a dish to the outer wall or roof of a structure.

1. What I claim as my invention is the use of an acrylic material such as Plexiglas, of which there are many, instead of ordinary glass in a window or opening of a structure facing a satellite thereby enabling a television satellite signal or transmission to pass through the window or opening, without distorting, to the satellite dish located within the structure or dwelling and eliminating the need to secure the satellite dish to the outside wall or on top of the structure or dwelling.
